(19) United States
(12) Patent Application Publication
(10) Pub. No.: US 2023/0208730 A1
(43) Pub. Date: Jun. 29, 2023

(54) Classification of Traffic Data Per Application Type

(71) Applicant: Telefonaktiebolaget LM Ericsson (publ), Stockholm (SE)

(72) Inventor: Miguel Angel Puente Pestaña, Madrid (ES)

(21) Appl. No.: 17/925,715

(22) PCT Filed: Feb. 23, 2021
(86) PCT No.: PCT/EP2021/054425

§ 371 Date: Nov. 16, 2022

(30) Foreign Application Priority Data
Jul. 9, 2020 (EP) 20382621.9

(51) Int. Cl. H04L 43/08

(52) U.S. Cl. CPC H04L 43/08

(57) ABSTRACT

There is provided mechanisms for generation of an application type specific traffic model. A method is performed by an NWDAF node. The method comprises obtaining instructions from an OAM node to identify an application type as specified by the instructions. The method comprises obtaining a list of applications belonging to the application type from a UDR node. The method comprises generating the application type specific traffic model by identifies a traffic pattern in traffic data as collected from a UPF node for the application type and by associating the traffic pattern with the application type in the application type specific traffic model.

### TECHNICAL FIELD

Embodiments presented herein relate to a method, a Network Data Analytics Function (NWDAF) node, a computer program, and a computer program product for generation of an application type specific traffic model. Further embodiments presented herein relate to a method, a Unified Data Repository (UDR) node, a computer program, and a computer program product for provision of application type specific traffic models. Further embodiments presented herein relate to a method, a User Plane Function (UPF) node, a computer program, and a computer program product for classifying data traffic.

### BACKGROUND

In communications networks, there may be a challenge to obtain good performance and capacity for a given communications protocol, its parameters and the physical environment in which the communications network is deployed.

For example, one parameter in providing good performance and capacity for a given communications protocol in a communications network is handling of policies and rules. Policies and rules might be specified per application (App-ID). For example, the Application Function (AF) can provide to the Network exposure Function (NEF) the Packet Flow Descriptors (PFDs) per App-ID to classify traffic of an application. For example, the Policy and Charging Function (PCF) provides Policy and Charging Control (PCC) rules to the Session Management Function (SMF) that include the policies (e.g. pertaining to quality of service (QoS) to apply per user and per application (App-ID)). For example, the SMF installs Packet Detection Rules (PDRs) and other rules (e.g. QoS Enforcement Rules (QER)) in the User Plane Function (UPF) per Protocol Data Unit (PDU) session and application (App-ID).

Therefore, mobile network operators can only define policies and rules on a per user and application (App-ID) basis. This assumes that the mobile network operators can classify the traffic into applications (App-IDs). Unfortunately, this is becoming more and more challenging due to traffic encryption. The amount of traffic that mobile network operators cannot classify is therefore increasing due to the increasing adoption of traffic encryption. Further, the number of different applications is continuously increasing, and it is challenging for mobile network operators to define what policies to apply for each individual application.

Due to the above issues, a considerable traffic proportion might not be classified (either because the traffic is encrypted or because the application is unknown to the classifier). As a consequence, proper policies and rules cannot be applied to the thus unclassified traffic.

Hence, there is still a need for an improved classification of traffic data.

### SUMMARY

An object of embodiments herein is to provide improved classification of traffic data.

In some aspects this object is achieved by generating application type specific traffic model.

According to a first aspect there is presented a method for generation of an application type specific traffic model. The method is performed by an NWDAF node. The method comprises obtaining instructions from an OAM node to identify an application type as specified by the instructions. The method comprises obtaining a list of applications belonging to the application type from a UDR node. The method comprises generating the application type specific traffic model by identifies a traffic pattern in traffic data as collected from a UPF node for the application type and by associating the traffic pattern with the application type in the application type specific traffic model.

According to a second aspect there is presented an NWDAF node for generation of an application type specific traffic model. The NWDAF node comprises processing circuitry. The processing circuitry is configured to cause the NWDAF node to obtain instructions from an OAM node to identify an application type as specified by the instructions. The processing circuitry is configured to cause the NWDAF node to obtain a list of applications belonging to the application type from a UDR node. The processing circuitry is configured to cause the NWDAF node to generate the application type specific traffic model by identifies a traffic pattern in traffic data as collected from a UPF node for the application type and by associating the traffic pattern with the application type in the application type specific traffic model.

According to a third aspect there is presented a computer program for generation of an application type specific traffic model. The computer program comprises computer program code which, when run on processing circuitry of an NWDAF node, causes the NWDAF node to perform a method according to the first aspect.

In some aspects this object is achieved by provision of application type specific traffic models.

According to a fourth aspect there is presented a method for provision of application type specific traffic models. Each application type specific traffic model has its own association between traffic pattern and application type. The method is performed by a UDR node. The UDR node stores application type specific traffic models. The method comprises obtaining a query for one of the application type specific traffic models from a NEF node. The query identifies an application type. The method comprises, in response thereto, providing the application type specific traffic model of the identified application type to the NEF node.

According to a fifth aspect there is presented a UDR node for provision of application type specific traffic models, wherein each application type specific traffic model has its own association between traffic pattern and application type. The UDR node is configured to store application type specific traffic models and comprises processing circuitry. The processing circuitry is configured to cause the UDR node to obtain a query for one of the application type specific traffic models from a NEF node. The query identifies an application type. The processing circuitry is configured to cause the UDR node to, in response thereto, provide the application type specific traffic model of the identified application type to the NEF node.

According to a sixth aspect there is presented a computer program for provision of application type specific traffic models, wherein each application type specific traffic model has its own association between traffic pattern and application type, the computer program comprises computer program code which, when run on processing circuitry of a UDR node configured to store application type specific traffic models, causes the UDR node to perform a method according to the fourth aspect.

In some aspects this object is achieved by usage of application type specific traffic models for classification of data traffic.

According to a seventh aspect there is presented a method for classifying data traffic. The method is performed by a UPF node. The method comprises obtaining application type specific traffic models. Each application type specific traffic model has its own association between traffic pattern and application type. The method comprises classifying data traffic as monitored into application types in accordance with the application type specific traffic models.

According to an eighth aspect there is presented a UPF node for classifying data traffic. The UPF node comprises processing circuitry. The processing circuitry is configured to cause the UPF node to obtain application type specific traffic models. Each application type specific traffic model has its own association between traffic pattern and application type. The processing circuitry is configured to cause the UPF node to classify data traffic as monitored into application types in accordance with the application type specific traffic models.

According to a tenth aspect there is presented a computer program for classifying data traffic, the computer program comprising computer program code which, when run on processing circuitry of a UPF node 300, causes the UPF node 300 to perform a method according to the seventh aspect.

According to an eleventh aspect there is presented a computer program product comprising a computer program according to at least one of the third aspect, the sixth aspect, and the tenth aspect and a computer readable storage medium on which the computer program is stored. The computer readable storage medium can be a non-transitory computer readable storage medium.

Advantageously these methods, this NWDAF node, this UDR node, this UPF node, these computer programs, and this computer program product enable improved classification of traffic data with respect to state of the art as disclosed above.

Advantageously these methods, this NWDAF node, this UDR node, this UPF node, these computer programs, and this computer program product enable detection and identification of traffic belonging to specific application types.

Advantageously these methods, this NWDAF node, this UDR node, this UPF node, these computer programs, and this computer program product enable application of policies and rules to traffic that cannot be classified as belonging to a specific application but can be classified as belonging to specific application type.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2, 3, and 4 are flowcharts of methods according to embodiments;

FIGS. 5, 6, and 7 are signalling diagrams according to embodiments;

FIG. 8 is a schematic diagram showing functional units of an NWDAF node according to an embodiment;

FIG. 9 is a schematic diagram showing functional modules of an NWDAF node according to an embodiment;

FIG. 10 is a schematic diagram showing functional units of a UDR node according to an embodiment;

FIG. 11 is a schematic diagram showing functional modules of a UDR node according to an embodiment;

FIG. 12 is a schematic diagram showing functional units of a UPF node according to an embodiment;

FIG. 13 is a schematic diagram showing functional modules of a UPF node according to an embodiment; and

FIG. 14 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The wording that a certain data item or piece of information is obtained by a first node should be construed as that data item or piece of information being retrieved, fetched, received, or otherwise made available to the first node. For example, the data item or piece of information might either be pushed to the first node from a second node or pulled by the first node from a second node. Further, in order for the first node to obtain the data item or piece of information, the first node might be configured to perform a series of operations, possible including interaction with the second node. Such operations, or interactions, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the first node.

The wording that a certain data item or piece of information is provided by a first node to a second node should be construed as that data item or piece of information being sent or otherwise made available to the second node by the first node. For example, the data item or piece of information might either be pushed to the second node from the first node or pulled by the second node from the second node. Further, in order for the first node to provide the data item or piece of information to the second node, the first node and the second node might be configured to perform a series of operations in order to interact with each other. Such operations, or interaction, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the second node.

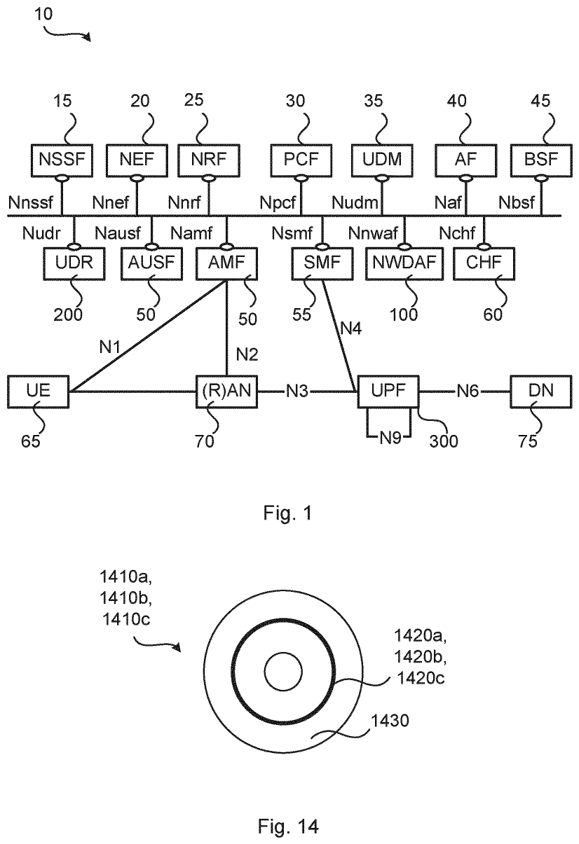

FIG. 1 is a schematic diagram illustrating a communications network 100 where embodiments presented herein can be applied. The communication network 100 might be regarded as a public land mobile network (PLMN) and represents a reference architecture of a fifth generation telecommunication system (5GS) and comprises the following entities: an Authentication Server Function (AUSF) node 50, an Access and Mobility Management Function (AMF) node 50, a Data Network (DN) 75, e.g. operator services, Internet access or third party services, a Network Exposure Function (NEF) node 20, a Network Repository Function (NRF) node 25, a Network Slice Selection Function (NSSF) node 15, a Policy Control Function (PCF) node 30, a Session Management Function (SMF) node 55, a Unified Data Manager (UDM) node 35, a Unified Data Repository (UDR) node 200, a User Plane Function (UPF) node 300, an Application Function (AF) node 40, a User Equipment (UE) 65, a (Radio) Access Network ((R)AN) 70, a Network Data Analytics Function (NWDAF) node 100, a Binding Support Function (BSF) node 45, and a Charging Function (CHF) node 60. Service based interfaces are represented by the format Nxyz (e.g., Nnssf, Nnef, etc.) and point to point interfaces are represented by the format Nx (e.g. N1, N2, etc.).

As disclosed above there is still a need for an improved classification of traffic data.

The embodiments disclosed herein thus relate to mechanisms for classification of traffic data per application type. In order to obtain such mechanisms there is provided an NWDAF node 100, a method performed by the NWDAF node 100, a computer program product comprising code, for example in the form of a computer program, that when run on processing circuitry of the NWDAF node 100, causes the NWDAF node 100 to perform the method. In order to obtain such mechanisms there is further provided a UDR node 200, a method performed by the UDR node 200, and a computer program product comprising code, for example in the form of a computer program, that when run on processing circuitry of the UDR node 200, causes the UDR node 200 to perform the method. In order to obtain such mechanisms there is further provided a UPF node 300, a method performed by the UPF node 300, and a computer program product comprising code, for example in the form of a computer program, that when run on processing circuitry of the UPF node 300, causes the UPF node 300 to perform the method.

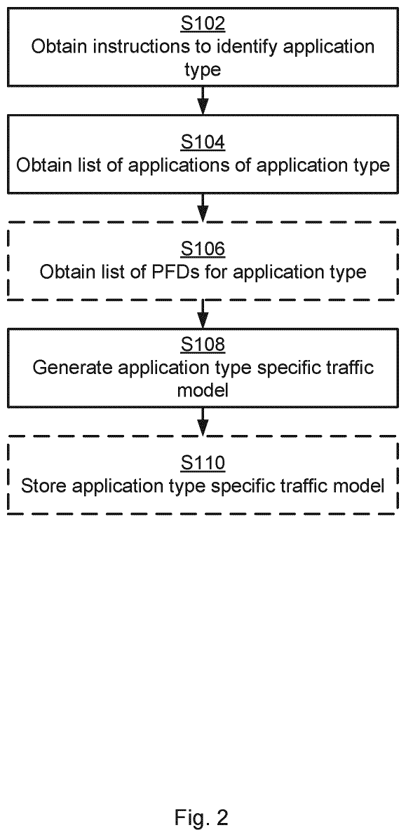

Reference is now made to FIG. 2 illustrating a method for generation of an application type specific traffic model as performed by the NWDAF node 100 according to an embodiment.

S102: The NWDAF node 100 obtains instructions from an operations and maintenance (OAM) node to identify an application type as specified by the instructions.

S104: The NWDAF node 100 obtains a list of applications belonging to the application type from a UDR node 200.

S108: The NWDAF node 100 generates the application type specific traffic model by identifying a traffic pattern in traffic data as collected from a UPF node 300 for the application type and by associating the traffic pattern with the application type in the application type specific traffic model.

Embodiments relating to further details of generation of an application type specific traffic model as performed by the NWDAF node 100 will now be disclosed.

There could be different application types. In some non-limiting examples, the application type is any of: video, audio, speech, text, augmented reality, virtual reality, IoT communication, automotive communication.

There could be different types of instructions obtained in step S102. In some embodiments, the instructions comprise a list of application identifiers registered as belonging to the application type.

There could be different types of lists of applications. In some embodiments, the list of applications is defined by a list of application identifiers registered as belonging to the application type.

In some aspects, in addition to obtaining the list of applications belonging to the application type in step S104, the NWDAF node 100 might further obtain a list of PFDs for the application type. Hence, according to an embodiment, the NWDAF node 100 is configured to perform (optional) step S106:

S106: The NWDAF node 100 obtains a list of PFDs for the application type. The PFDs specify which IP addresses are associated with the applications of the application type.

In this respect, the PFDs might comprise traffic filters needed to classify the traffic according to the application identifiers.

The PFDs might then be used for identifying which traffic data belongs to which application. In particular, in some embodiments, the traffic data is identified as belonging to the application type by the traffic data comprising the PFDs for the application type.

Once the model has been generated, the NWDAF node 100 might store the application type specific traffic model. There could be different entities in which the model is stored. In some aspects, the model is stored in the UDR node 200. Thus, in some embodiments, the NWDAF node 100 is configured to perform (optional) step S110:

S110: The NWDAF node 100 stores the application type specific traffic model in the UDR node 200.

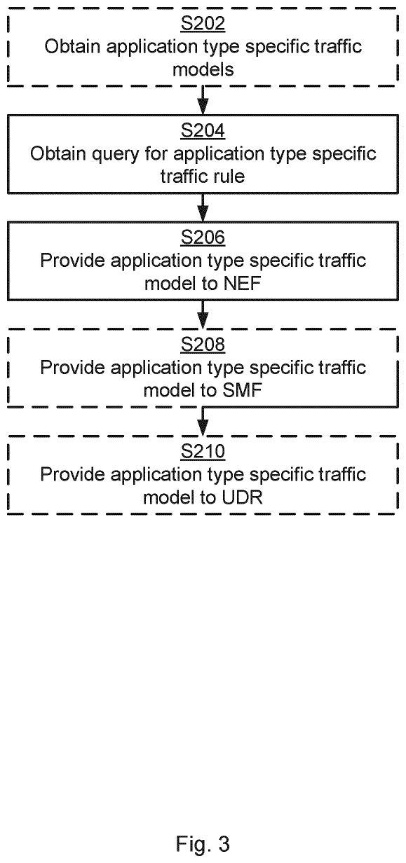

Reference is now made to FIG. 3 illustrating a method for provision of application type specific traffic models as performed by the UDR node 200 according to an embodiment. Each application type specific traffic model has its own association between traffic pattern and application type. The UDR node 200 stores application type specific traffic models.

S204: The UDR node 200 obtains a query for one of the application type specific traffic models from a NEF node 20. The query identifies an application type.

S206: The UDR node 200, in response thereto (i.e., in response to having obtained the query in step S204), provides the application type specific traffic model of the identified application type to the NEF node 20.

Embodiments relating to further details of provision of application type specific traffic models as performed by the UDR node 200 will now be disclosed.

There could be different ways for the UDR node 200 to obtain the application type specific traffic models. In some aspects, the models are obtained from the UDR node 200. Hence, according to an embodiment, the UDR node 200 is configured to perform (optional) step S202:

S202: The UDR node 200 obtains the application type specific traffic models from an NWDAF node 100.

In addition to providing the application type specific traffic model of the identified application type to the NEF node 20, the UDR node 200 might further (or even alternatively) provide the model to the SMF node 55. Hence, according to an embodiment, the UDR node 200 is configured to perform (optional) step S208:

S208: The UDR node 200 provides the application type specific traffic model of the identified application type to an SMF node 55.

addition to providing the application type specific traffic model of the identified application type to the NEF node 20, the UDR node 200 might further (or even alternatively) provide the model to the UDR node 200. Hence, according to an embodiment, the UDR node 200 is configured to perform (optional) step S208:

S210: The UDR node 200 provides the application type specific traffic model of the identified application type to a UDR node 200 via the NEF node 20.

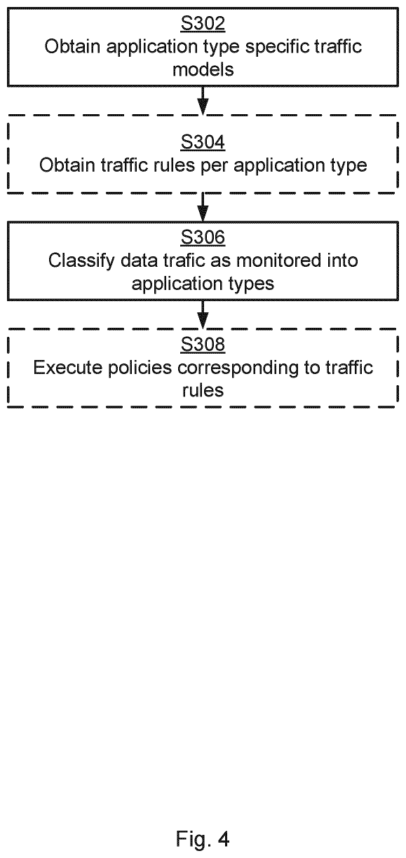

Reference is now made to FIG. 4 illustrating a method for classifying data traffic as performed by the UPF node 300 according to an embodiment.

The UPF node 300 uses an application type specific traffic model to classify traffic into application type

S302: The UPF node 300 obtains application type specific traffic models. Each application type specific traffic model has its own association between traffic pattern and application type.

S306: The UPF node 300 classifies data traffic as monitored into application types in accordance with the application type specific traffic models.

Embodiments relating to further details of classifying data traffic as performed by the UPF node 300 will now be disclosed.

There could be different ways for the UPF node 300 to obtain the application type specific traffic models in step S302. In some embodiments, the application type specific traffic models are obtained from an SMF node 55. The models might be obtained in an N4 PFD Management Request message. In some embodiments, the application type specific traffic models are obtained from a UDR node 200 via a NEF node 20.

In some aspects, traffic rules are by the UPF node 200 used when executing policies. In some embodiments, the UPF node 200 is therefore configured to perform (optional) step S304:

S304: The UPF node 300 obtains traffic rules per application type from an SMF node 55.

There could be different types pf traffic rules. In some non-limiting examples, the traffic rules are defined by any of: PDRs, QERs, Forwarding Action Rules (FARs), Usage Reporting Rules (URRs), Buffering Action Rules (BARs).

Upon having obtained the traffic rules, the UPF node 200 might execute polices corresponding to the traffic rules. Hence, in some embodiments, the UPF node 200 is configured to perform (optional) step S308:

S308: The UPF node 300 executes, for the data traffic as classified into application types, polices corresponding to the traffic rules, where the policies are configured per application type.

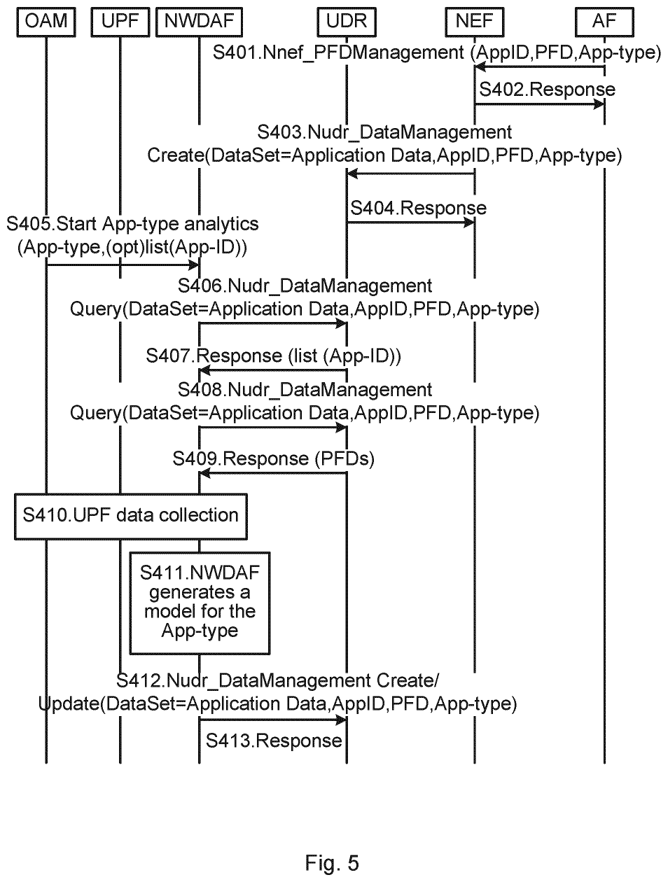

One particular embodiment for generating application type specific traffic models based on at least some of the above disclosed embodiments will now be disclosed in detail with reference to the signalling diagram of FIG. 5.

S401: The AF node 40 invokes the Nnef_PFDManagement service in the NEF node 20 by in a Nnef_PFDManagement message to the NEF node 20 including App-ID, PFDs, application type (App-type)

S402: The NEF node 20 responds to the AF node 40 to acknowledge the PFD provisioning.

S403: The NEF node 20 stores the information in the UDR node 200 by sending a Nudr_DataManagement Create message to the UDR node 200 including DataSet=Application Data (the data set used to store the PFDs), App-ID, PFDs, and App-type.

S404: The UDR node 200 responds to the NEF node 20 to acknowledge the registration of the information.

S405: An OAM node instructs the NWDAF node 100 to start an analytics processes to detect a certain App-type. In order to do so the OAM node sends to NWDAF node 100 a Start App-type analytics message including the target App-type and optionally, a list of App-IDs belonging to the App-type as known by the OAM node.

S406: The NWDAF node 100 retrieves from the UDR node 200 the App-IDs belonging to the App-type by sending to the UDR node 200 a Nudr_DataManagement Query message to the UDR node 200 including DataSet=Application Data, and App-type.

S407: The UDR node 200 responds to the NWDAF node 100 with the list of App-IDs registered as belonging to the App-type.

S408: The NWDAF 100, in order to classify the traffic belonging to the App-IDs, retrieves the PFDs from the UDR node 200 by sending a Nudr_DataManagement Query message to the UDR node 200 including DataSet=Application Data, and App-ID.

S409: The UDR node 200 responds to the NWDAF node 100 with the PFDs for the App-ID.

S410: The NWDAF node 100 collects the necessary traffic data from the UPF node 300.

S411: When the NWDAF node 100 detects a certain traffic pattern for an App-type, the NWDAF 100 generates a model to classify the traffic into the App-type.

S412: The NWDAF node 100 stores the model in the UDR node 200 by sending a Nudr_DataManagement Create/Update message to the UDR node 200 including DataSet=Application-type Data to store the App-type models in the UDR node 200, the App-type, and the model for the App-type.

S413: The UDR node 200 responds to the NWDAF 100 to acknowledge registration of the model.

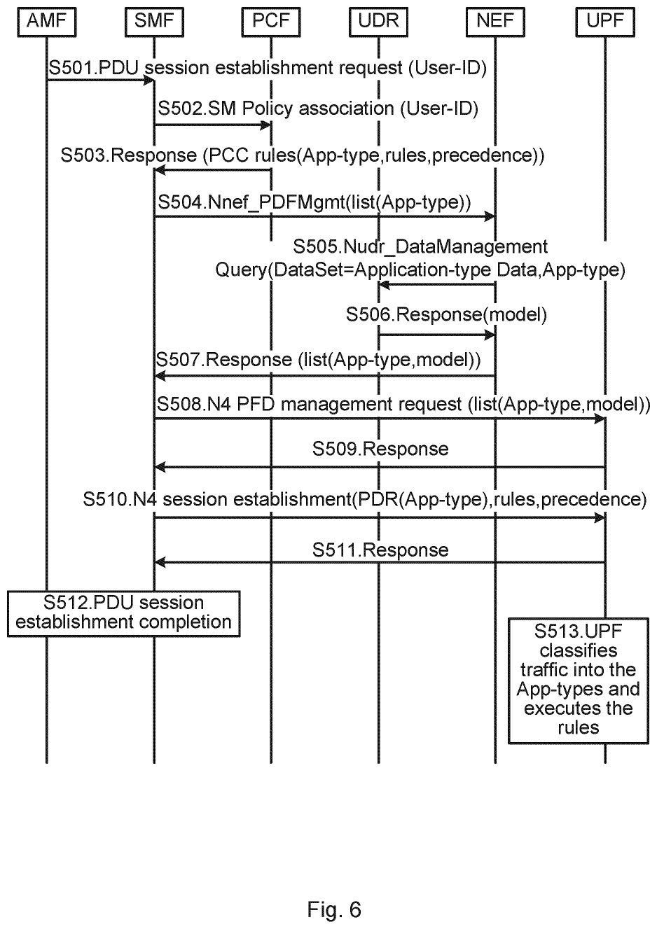

One particular embodiment for PDU session establishment and provisioning of the App-type models to the UPF node 300 based on at least some of the above disclosed embodiments will now be disclosed in detail with reference to the signalling diagram of FIG. 6.

S501: The AMF node 50 sends a PDU session establishment request to the SMF node 55 including the User-ID.

S502: The SMF node 55 requests the session management (SM) policy association from the PCF node 30 by including the User-ID in an SM policy association message to the PCF node 30.

S503: The PCF node 30 responds to the SMF node 55 with the PCC rules for the user in a response message. The response message includes rules per App-type, including App-type, PCC rules per App-type (indicating the rules that apply to the App-type), a precedence value associated to the rules of the App-type; this value can be also associated on a per rule basis.

S504: In order to obtain the traffic filters to send to the UPF node 300, the SMF node 55 sends a Nnef_PDFMgmt message to the NEF node 20 to invoke the PFD management service in the NEF node 20 for the App-IDs. In the message is included the App-type (or list of App-types) received from the PCF node 30 in the PCC rules.

S505: In order to retrieve the models for the App-types, the NEF node 20 sends a Nudr_DataManagement Query message to invokes the Nudr_DataManagement Query service operation in the UDR 200, where the message includes DataSet=Application-type Data, and App-type.

S506: The UDR node 200 responds to the NEF node 20 by sending the App-type models to the NEF node 20.

S507: The NEF node 20 responds to the SMF node 55 with a message including a list of tuples, where each tuple includes: (App-type, model).

S508: The SMF node 55 sends an N4 PFD Management request message to the UPF node 300, where the message includes the list of tuples (App-type, model).

S509: The UPF node 300 responds to the SMF node 500 in order to acknowledge the N4 PFD Management request.

S510: The SMF node 55 establishes the N4 session for the user with the UPF node 300 including the PDRs and associated rules (e.g. QER) by sending a N4 session establishment message to the UPF node 300. For the rules to apply to a certain App-type, the SMF node 55 includes in the message the App-type as matching information in the PDRs, the rules to apply for the PDR (e.g. QER), and the precedence associated to the rules of the App-type; this parameter can be also associated on a per rule basis.

S511: The UPF node 300 acknowledges the N4 session establishment in a response to the SMF node 55.

S512: The PDU session establishment process is completed between the SMF node 55 and the AMF node 50.

S513: The UPF node 300 can use the provided App-type models to classify the traffic into the corresponding App-types and execute the corresponding policies configured on a per App-type basis. If there are conflicts between the rules for an App-ID and the rules for an App-type, the UPF node 300 might use the precedence of the rules to decide which rule to apply.

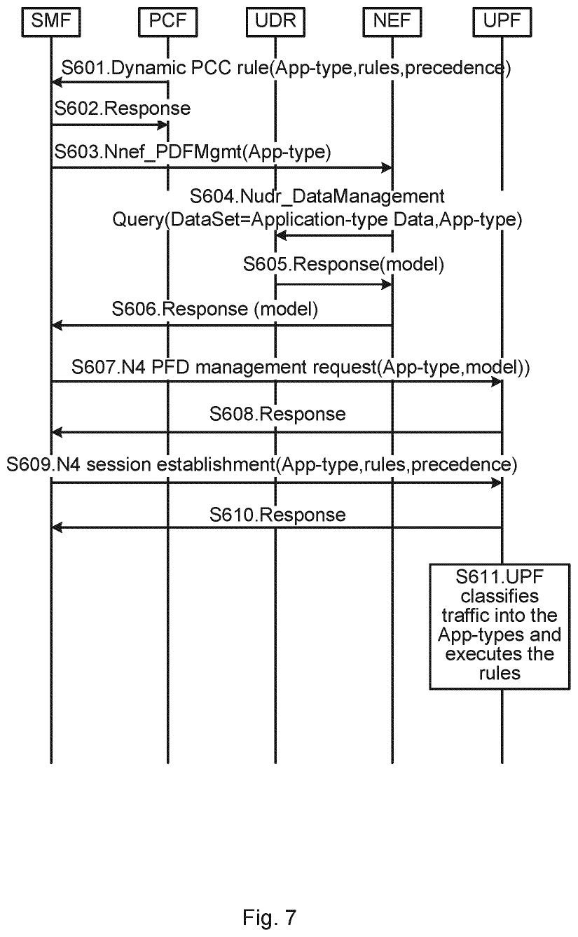

One particular embodiment where policies and rules (i.e. for all users) are provided by the PCF node 30 on a per App-type basis and then installed in the UPF node 300 by the SMF node 45 as based on at least some of the above disclosed embodiments will now be disclosed in detail with reference to the signalling diagram of FIG. 7.

S601: The PCF node 30 sends a dynamic PCC rule for an App-type to the SMF node 55, where the dynamic PCC rule includes App-type, PCC rules per App-type (indicating the rules that apply to the App-type), and a precedence value associated to the rules of the App-type; this value can be also associated on a per rule basis.

S602: The SMF node 55 responds to the PCF node 30 to acknowledge receipt of the PCC rule.

S603: In order to obtain the traffic filters to send to the UPF node 300, the SMF node 55 sends a Nnef_PDFMgmt message to the NEF node 20 to invoke the PFD management service in the NEF node 20 for the App-IDs. In the message is included the App-type (or list of App-types) received from the PCF node 30 in the PCC rules.

S604: In order to retrieve the models for the App-types, the NEF node 20 sends a Nudr_DataManagement Query message to invokes the Nudr_DataManagement Query service operation in the UDR 200, where the message includes DataSet=Application-type Data, and App-type.

S605: The UDR node 200 responds to the NEF node 20 by sending the App-type models to the NEF node 20.

S606: The NEF node 20 responds to the SMF node 55 with a message including a list of tuples, where each tuple includes: (App-type, model)

S607: The SMF node 55 sends an N4 PFD Management request message to the UPF node 300, where the message includes the list of tuples (App-type, model).

S608: The UPF node 300 responds to the SMF node 500 in order to acknowledge the N4 PFD Management request.

S609: The SMF node 55 sends a per node message to the UPF node 300 to configure the generic rules per App-type, including App-type, the rules to apply for the PDR (e.g. QoS rules), and the precedence associated to the rules of the App-type; this parameter can be also associated on a per rule basis.

S610: The UPF node 300 sends a response to the SMF node 550 to acknowledge receipt of the rules configuration.

S611: The UPF node 30 can use the provided App-type models to classify the traffic into the corresponding App-types and execute the corresponding policies configured on a per App-type basis. If there are conflicts between the rules for an App-ID and the rules for an App-type, the UPF node 300 might use the precedence of the rules to decide which rule to apply.

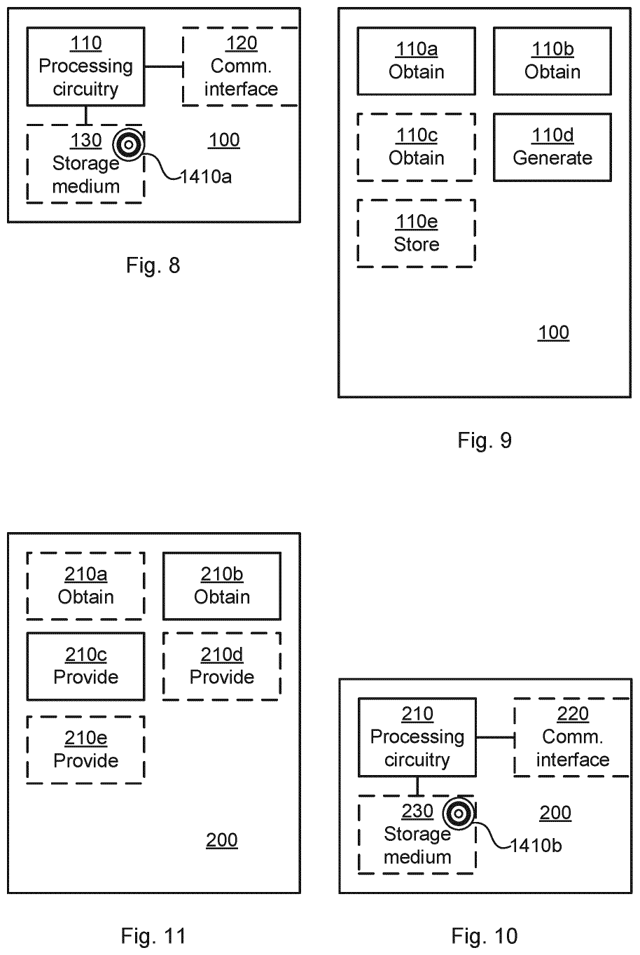

FIG. 8 schematically illustrates, in terms of a number of functional units, the components of an NWDAF node 100 according to an embodiment. Processing circuitry 110 is provided using any combination of one or more of a suitable central processing unit (CPU), multiprocessor, microcontroller, digital signal processor (DSP), etc., capable of executing software instructions stored in a computer program product 1410a (as in FIG. 14), e.g. in the form of a storage medium 130. The processing circuitry 110 may further be provided as at least one application specific integrated circuit (ASIC), or field programmable gate array (FPGA).

Particularly, the processing circuitry 110 is configured to cause the NWDAF node 100 to perform a set of operations, or steps, as disclosed above. For example, the storage medium 130 may store the set of operations, and the processing circuitry 110 may be configured to retrieve the set of operations from the storage medium 130 to cause the NWDAF node 100 to perform the set of operations. The set of operations may be provided as a set of executable instructions. Thus the processing circuitry 110 is thereby arranged to execute methods as herein disclosed.

The storage medium 130 may also comprise persistent storage, which, for example, can be any single one or combination of magnetic memory, optical memory, solid state memory or even remotely mounted memory.

The NWDAF node 100 may further comprise a communications interface 120 for communications with other entities in the network 10. As such the communications interface 120 may comprise one or more transmitters and receivers, comprising analogue and digital components.

The processing circuitry 110 controls the general operation of the NWDAF node 100 e.g. by sending data and control signals to the communications interface 120 and the storage medium 130 by receiving data and reports from the communications interface 120, and by retrieving data and instructions from the storage medium 130. Other components, as well as the related functionality, of the NWDAF node 100 are omitted in order not to obscure the concepts presented herein.

FIG. 9 schematically illustrates, in terms of a number of functional modules, the components of an NWDAF node 100 according to an embodiment. The NWDAF node 100 of FIG. 9 comprises a number of functional modules; an obtain module 110a configured to perform step S102, an obtain module nob configured to perform step S104, and a generate module 110d configured to perform step S108. The NWDAF node 100 of FIG. 9 may further comprise a number of optional functional modules, such as any of an obtain module 110c configured to perform step S106, and a store module 110e configured to perform step S110. In general terms, each functional module 110a-110e may be implemented in hardware or in software. Preferably, one or more or all functional modules 110a-110e may be implemented by the processing circuitry 110, possibly in cooperation with the communications interface 120 and the storage medium 130. The processing circuitry 110 may thus be arranged to from the storage medium 130 fetch instructions as provided by a functional module 110a-110e and to execute these instructions, thereby performing any steps of the NWDAF node 100 as disclosed herein.

FIG. 10 schematically illustrates, in terms of a number of functional units, the components of a UDR node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1410b (as in FIG. 14), e.g. in the form of a storage medium 230. The processing circuitry 210 may further be provided as at least one application specific integrated circuit (ASIC), or field programmable gate array (FPGA).

Particularly, the processing circuitry 210 is configured to cause the UDR node 200 to perform a set of operations, or steps, as disclosed above. For example, the storage medium 230 may store the set of operations, and the processing circuitry 210 may be configured to retrieve the set of operations from the storage medium 230 to cause the UDR node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The UDR node 200 may further comprise a communications interface 220 for communications with other entities in the network 10. As such the communications interface 220 may comprise one or more transmitters and receivers, comprising analogue and digital components.

The processing circuitry 210 controls the general operation of the UDR node 200 e.g. by sending data and control signals to the communications interface 220 and the storage medium 230, by receiving data and reports from the communications interface 220, and by retrieving data and instructions from the storage medium 230. Other components, as well as the related functionality, of the UDR node 200 are omitted in order not to obscure the concepts presented herein.

FIG. 11 schematically illustrates, in terms of a number of functional modules, the components of a UDR node 200 according to an embodiment. The UDR node 200 of FIG. 11 comprises a number of functional modules; an obtain module 210b configured to perform step S204, and a provide module 210c configured to perform step S206. The UDR node 200 of FIG. 11 may further comprise a number of optional functional modules, such as any of an obtain module 210a configured to perform step S202, a provide module 210d configured to perform step S208, and a provide module 210e configured to perform step S210. In general terms, each functional module 210a-210e may be implemented in hardware or in software. Preferably, one or more or all functional modules 210a-210e may be implemented by the processing circuitry 210, possibly in cooperation with the communications interface 220 and the storage medium 230. The processing circuitry 210 may thus be arranged to from the storage medium 230 fetch instructions as provided by a functional module 210a-210e and to execute these instructions, thereby performing any steps of the UDR node 200 as disclosed herein.

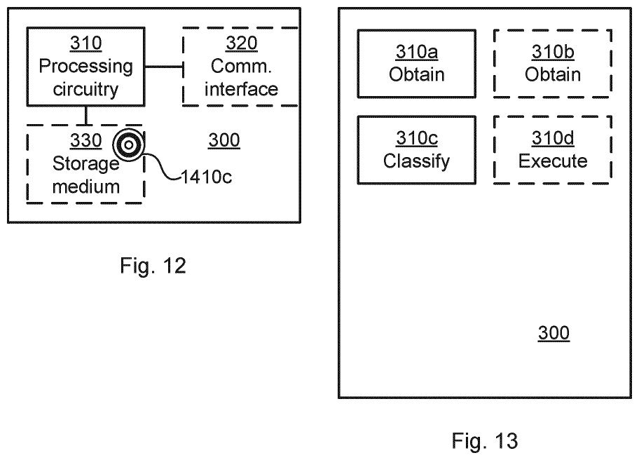

FIG. 12 schematically illustrates, in terms of a number of functional units, the components of a UPF node 300 according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1410c (as in FIG. 14), e.g. in the form of a storage medium 330. The processing circuitry 310 may further be provided as at least one application specific integrated circuit (ASIC), or field programmable gate array (FPGA).

Particularly, the processing circuitry 310 is configured to cause the UPF node 300 to perform a set of operations, or steps, as disclosed above. For example, the storage medium 330 may store the set of operations, and the processing circuitry 310 may be configured to retrieve the set of operations from the storage medium 330 to cause the UPF node 300 to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The UPF node 300 may further comprise a communications interface 320 for communications with other entities in the network 10. As such the communications interface 320 may comprise one or more transmitters and receivers, comprising analogue and digital components.

The processing circuitry 310 controls the general operation of the UPF node 300 e.g. by sending data and control signals to the communications interface 320 and the storage medium 330, by receiving data and reports from the communications interface 320, and by retrieving data and instructions from the storage medium 330. Other components, as well as the related functionality, of the UPF node 300 are omitted in order not to obscure the concepts presented herein.

FIG. 13 schematically illustrates, in terms of a number of functional modules, the components of a UPF node 300 according to an embodiment. The UPF node 300 of FIG. 13 comprises a number of functional modules; an obtain module 310a configured to perform step S302, and a classify module 310c configured to perform step S306. The UPF node 300 of FIG. 13 may further comprise a number of optional functional modules, such as any of an obtain module 310b configured to perform step S304, and an execute module 310d configured to perform step S308. In general terms, each functional module 310a-310d may be implemented in hardware or in software. Preferably, one or more or all functional modules 310a-310d may be implemented by the processing circuitry 310, possibly in cooperation with the communications interface 320 and the storage medium 330. The processing circuitry 310 may thus be arranged to from the storage medium 330 fetch instructions as provided by a functional module 310a-310d and to execute these instructions, thereby performing any steps of the UPF node 300 as disclosed herein.

Each of the NWDAF node 100, the UDR node 200, and the UPF node 300 may be provided as a standalone device or as a part of at least one further device. For example, the NWDAF node 100, the UDR node 200, and the UPF node 300 may be provided in a respective node of the core network. Alternatively, functionality of the NWDAF node 100, the UDR node 200, and the UPF node 300 may be distributed between at least two nodes in the core network) or may be spread between at least two such network parts. A first portion of the instructions performed by the NWDAF node 100, the UDR node 200, and the UPF node 300 may be executed in a first device, and a second portion of the of the instructions performed by the NWDAF node 100, the UDR node 200, and the UPF node 300 may be executed in a second device; the herein disclosed embodiments are not limited to any particular number of devices on which the instructions performed by the NWDAF node 100, the UDR node 200, and the UPF node 300 may be executed. Hence, the methods according to the herein disclosed embodiments are suitable to be performed by an NWDAF node 100, UDR node 200, and UPF node 300 residing in a cloud computational environment. Therefore, although a single processing circuitry 110, 210, 310 is illustrated in FIGS. 8, 10, 12 the processing circuitry 110, 210, 310 may be distributed among a plurality of devices, or nodes. The same applies to the functional modules 110a-110e, 210a:210e, 310a:310d of FIGS. 9, 11, 13 and the computer programs 1420a, 1420b, 1420c of FIG. 14.

FIG. 14 shows one example of a computer program product 1410a, 1410b, 1410c comprising computer readable means 1430. On this computer readable means 1430, a computer program 1420a can be stored, which computer program 1420a can cause the processing circuitry 110 and thereto operatively coupled entities and devices, such as the communications interface 120 and the storage medium 130, to execute methods according to embodiments described herein. The computer program 1420a and/or computer program product 1410a may thus provide means for performing any steps of the NWDAF node 100 as herein disclosed. On this computer readable means 1430, a computer program 1420b can be stored, which computer program 1420b can cause the processing circuitry 210 and thereto operatively coupled entities and devices, such as the communications interface 220 and the storage medium 230, to execute methods according to embodiments described herein. The computer program 1420b and/or computer program product 1410b may thus provide means for performing any steps of the UDR node 200 as herein disclosed. On this computer readable means 1430, a computer program 1420c can be stored, which computer program 1420c can cause the processing circuitry 310 and thereto operatively coupled entities and devices, such as the communications interface 320 and the storage medium 330, to execute methods according to embodiments described herein. The computer program 1420c and/or computer program product 1410c may thus provide means for performing any steps of the UPF node 300 as herein disclosed.

In the example of FIG. 14, the computer program product 1410a, 1410b, 1410c is illustrated as an optical disc, such as a CD (compact disc) or a DVD (digital versatile disc) or a Blu-Ray disc. The computer program product 1410a, 1410b, 1410c could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1420a, 1420b, 1420c is here schematically shown as a track on the depicted optical disk, the computer program 1420a, 1420b, 1420c can be stored in any way which is suitable for the computer program product 1410a, 1410b, 1410c.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-32. (canceled)

33. A method performed by a Network Data Analytics Function (NWDAF) node, the method comprising:
obtaining instructions from an Operations and Maintenance (OAM) node to identify an application type as specified by the instructions;
obtaining a list of applications belonging to the application type from a Unified Data Repository (UDR) node; and
generating an application type specific traffic model by identifying a traffic pattern in traffic data as collected from a User Plane Function (UPF) node for the application type and by associating the traffic pattern with the application type in the application type specific traffic model.

34. The method of claim 33, wherein the instructions comprise a list of application identifiers registered as belonging to the application type.

35. The method of claim 33, wherein the list of applications is defined by a list of application identifiers registered as belonging to the application type.

36. The method of claim 33, further comprising obtaining a list of Packet Flow Descriptors (PFDs) for the application type, wherein the PFDs specify which IP addresses are associated with the applications of the application type.

37. The method of claim 36, wherein the traffic data is identified as belonging to the application type by the traffic data comprising the PFDs for the application type.

38. The method of claim 33, further comprising storing the application type specific traffic model in the UDR node.

39. The method of claim 33, wherein the application type is any of: video, audio, speech, text, augmented reality, virtual reality, IoT communication, or automotive communication.

40. A Network Data Analytics Function (NWDAF) node comprising:
processing circuitry and memory comprising instructions executable by the processing circuitry whereby the network node is configured to:
obtain instructions from an Operations and Maintenance (OAM) node to identify an application type as specified by the instructions;
obtain a list of applications belonging to the application type from a Unified Data Repository (UDR) node; and
generate an application type specific traffic model by identifying a traffic pattern in traffic data as collected from a User Plane Function (UPF) node for the application type and by associating the traffic pattern with the application type in the application type specific traffic model.

41. The NWDAF node of claim 40, wherein the instructions comprise a list of application identifiers registered as belonging to the application type.

42. The NWDAF node of claim 40, wherein the list of applications is defined by a list of application identifiers registered as belonging to the application type.

43. The NWDAF node of claim 40, wherein the processing circuity is further configured to obtain a list of Packet Flow Descriptors (PFDs) for the application type, wherein the PFDs specify which IP addresses are associated with the applications of the application type.

44. The NWDAF node of claim 43, wherein the traffic data is identified as belonging to the application type by the traffic data comprising the PFDs for the application type.

45. The NWDAF node of claim 40, wherein the processing circuity is further configured to store the application type specific traffic model in the UDR node.

46. The NWDAF node of claim 40, wherein the application type is any of: video, audio, speech, text, augmented reality, virtual reality, IoT communication, automotive communication.

47. A non-transitory computer-readable storage medium storing computer-readable program instructions that, when executed on processing circuitry of a Network Data Analytics Function (NWDAF) node, cause the NWDAF node to:
obtain instructions from an Operations and Maintenance (OAM) node to identify an application type as specified by the instructions;
obtain a list of applications belonging to the application type from a Unified Data Repository (UDR) node; and
generate the application type specific traffic model by identifying a traffic pattern in traffic data as collected from a User Plane Function (UPF) node for the application type and by associating the traffic pattern with the application type in the application type specific traffic model.

48. The non-transitory computer-readable storage medium of claim 47, wherein the instructions comprise a list of application identifiers registered as belonging to the application type.

49. The non-transitory computer-readable storage medium of claim 47, wherein the list of applications is defined by a list of application identifiers registered as belonging to the application type.

50. The non-transitory computer-readable storage medium of claim 47, wherein the program instructions further cause the NWDAF node to obtain a list of Packet Flow Descriptors (PFDs) for the application type, wherein the PFDs specify which IP addresses are associated with the applications of the application type.

51. The non-transitory computer-readable storage medium of claim 50, wherein the traffic data is identified as belonging to the application type by the traffic data comprising the PFDs for the application type.

52. The non-transitory computer-readable storage medium of claim 47, wherein the application type is any of: video, audio, speech, text, augmented reality, virtual reality, IoT communication, automotive communication.
